(19) United States
(12) Patent Application Publication
(10) Pub. No.: US 2015/0300842 A1
(43) Pub. Date: Oct. 22, 2015

(54) Device and Method For Determining the Change of Position of a 3D Measuring Head

(71) Applicant: AiMESS Services GmbH, Burg (DE)

(72) Inventor: Ernst Wiedenmann, Aalen (DE)

(21) Appl. No.: 14/601,818

(22) Filed: Jan. 21, 2015

(30) Foreign Application Priority Data
Jan. 21, 2014 (EP) 14 151 947.0

(51) Int. Cl. G01D 5/20

(52) U.S. Cl. CPC G01D 5/20

(57) ABSTRACT

The invention relates to a device for determining the change of position of a 3D measuring head, comprising a 3D measuring head; at least one sensor device, connected to the 3D measuring head, to detect a respective position-dependent measured quantity; and an evaluating device for determining a change of position of the 3D measuring head at a final position relative to a starting position from the at least one detected measured quantity; wherein the change of position includes a displacement in space and a rotation in space. The invention further relates to a corresponding method.

### FIELD OF THE INVENTION

The invention relates to a device and a method for determining the change of position of a 3D measuring head.

### PRIOR ART

So far, three different methods are used in the prior art for registering different recordings of an object using a 3D measuring head. Firstly, marks or geometrical bodies (e.g. balls) may be attached to the object to be measured, which are recognized in different recordings due to their position relative to one another, or by a unique coding, and are then registered relative to one another. Secondly, positioning systems (e.g. robot arm, 3D coordinate measuring machine) may be employed, which exactly determine the spatial position of the measuring head. Thirdly, the universal method to be used are software algorithms (e.g. ICP), trying to superimpose the point clouds of the different measurements to generate one point cloud in a uniform coordinate system. This last-mentioned method has the great disadvantage, however, that it only works with bodies that have distinctive characteristics. In principle, it is impossible to thus register a bail. The mathematical orienting methods known so far therefore only work in a very limited object area.

### DESCRIPTION OF THE INVENTION

It is the object of the invention to provide a device and a method not involving the aforementioned disadvantages.

This object is achieved by a device according to the invention as defined in patent claim 1.

The device according to the invention for determining the change of position of a 3D measuring head comprises a 3D measuring head; at least one sensor device, connected to the 3D measuring head, to detect a respective position-dependent measured quantity; and an evaluating device for determining a change of position of the 3D measuring head at a final position relative to a starting position from the at least one detected measured quantity; wherein the change of position includes a displacement in space and a rotation in space.

It is thus possible, for example, to calculate the internal coordinate system of the measuring head at a new position by means of the sensor data from the coordinate system of the original position. The new coordinate system is here a result of an optional displacement and rotation based on the original coordinate system.

The device according to the invention can be improved in that the evaluating device may be further adapted to determine changes of position at further final positions. Thus, it is possible, for example, to relate several recordings from different perspectives to each other.

Another improvement consists in that the evaluating device may be further adapted to calculate an internal coordinate system of each final position on the basis of the internal coordinate system of the starting position. Thus, each internal coordinate system of each final position is registered with the internal coordinate system of the starting position.

According to another improvement each sensor device may comprise one sensor or several sensors. This can increase the accuracy of the measurement.

Another improvement of the aforementioned improvement consists in that each sensor may be selected from the group comprising magnetometer, WLAN sensor, mobile radio receiver, gyroscope, Bluetooth sensor, acceleration sensor, and rotation rate sensor. Thus, it is possible to apply and combine different physical quantities to determine the change of position.

According to another improvement the device according to the invention, or an improvement thereof, may further comprise means for generating the respective position-dependent measured quantity. This has the advantage that the measured quantity, whose change is detected upon the change of position of the measuring head, is controllable, e.g. with respect to direction and quantity. For example, an electric coil for generating an inhomogeneous magnetic field could be provided if the sensor is a magnetic field sensor.

Another improvement consists in that the 3D measuring head may be a tactile measuring head, an optical measuring head, a light section sensor or a laser scanner.

The aforementioned object is further achieved by the method according to the invention as defined in claim 8.

The method according to the invention for determining the change of position of a 3D measuring head comprises the steps of: moving the 3D measuring head from a starting position into a final position; detecting at least one position-dependent measured quantity by a respective sensor device fixed to the 3D measuring head; and determining a change of position of the 3D measuring head at the final position relative to the starting position on the basis of the at least one detected position-dependent measured quantity; wherein the determination of the change of position comprises the determination of a displacement in space and the determination of a rotation in space.

The advantages of the method according to the invention and the improvements thereof described below correspond to those of the device according to the invention and the improvements thereof.

The method according to the invention may be further improved in that generating the position-dependent measured quantity is performed beforehand as an additional step. For example, a magnetic field can be generated, which can then be detected by a magnetometer as the sensor.

The method according to the invention or the aforementioned improvement can be further improved in that the method may further comprise moving the 3D measuring head to further final positions, and determining the change of position at the further final positions.

Another improvement consists in that the following further step may be provided: calculating an internal coordinate system of each final position on the basis of the internal coordinate system of the starting position.

According to another improvement the change of position in space can be determined with respect to three linearly independent axes of displacement of the internal coordinate system of the starting position or the final position, and the rotation in space can be determined with respect to three linearly independent axes of rotation of the internal coordinate system of the starting position or the final position, wherein the three axes of displacement are preferably identical with the three axes of rotation.

Another improvement of the aforementioned improvement consists in that the three linearly independent position axes are perpendicular to one another and/or wherein the three linearly independent axes of rotation are perpendicular to one another.

According to another improvement the method may comprise the following additional step: registering the internal coordinate system of each final position in a world coordinate system.

Another improvement of the aforementioned improvement consists in that points measured by the 3D measuring head are represented in the world coordinate system.

The improvements may be applied independently of each other, combined with one another in an appropriate manner.

### BRIEF DESCRIPTION OF THE DRAWINGS

FIG. 1 schematically shows an embodiment of the device according to the invention.

### DESCRIPTION OF THE EMBODIMENTS

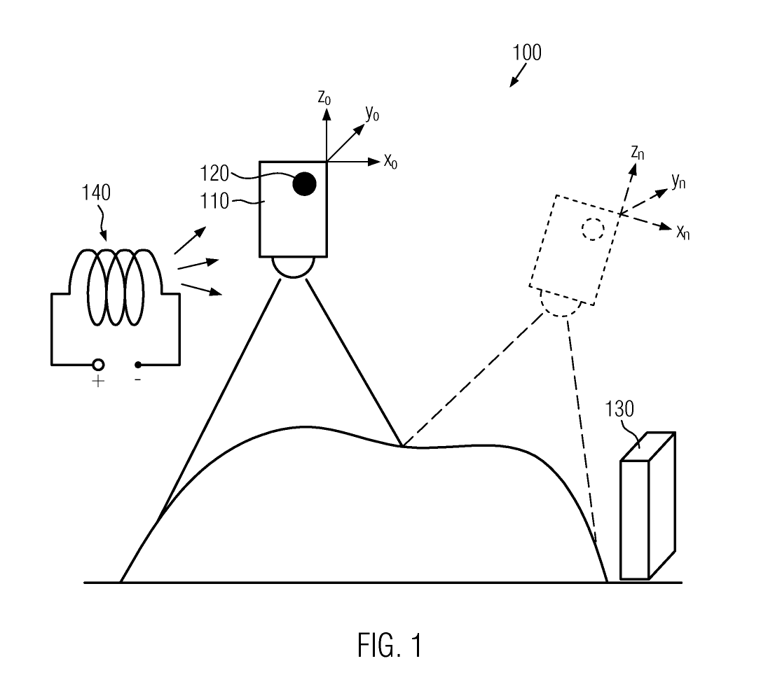

FIG. 1 schematically shows a device according to the invention for determining the change of position of a 3D measuring head.

In this embodiment, the device 100 comprises a 3D measuring head 110, at least one sensor 120, connected to the 3D measuring head, to detect a position-dependent measured quantity, and an evaluating device 130 to determine a change of position of the 3D measuring head at a final position relative to a starting position on the basis of the at least one detected measured quantity; wherein the change of position comprises a displacement in space and a rotation in space. In this embodiment, the 3D measuring head is provided, for example, as a laser scanner. The sensor 120 may be a magnetometer for measuring the quantity and direction of a magnetic field, predetermined in a defined manner, at the location of the sensor. In this case, a unit 140 for generating an inhomogeneous magnetic field may optionally be provided, which magnetic field is detected by the magnetometer. Finally, the detected measured values may be transmitted to an evaluating device 130 in the form of a computer (wired or wireless). Upon a change of position of the measuring head 120 from an original position with the coordinate system O₀ (X₀, Y₀, Z₀) to a new position with the coordinate system Oₙ (Xₙ, Yₙ, Zₙ) a rotation may occur in addition to a displacement. Based on the changed measured quantity of the sensor 120 it is possible to register, with the aid of the evaluating device 130, the new coordinate system with respect to the original one.

With regard to the sensors measuring an inhomogeneous spatial field, theoretically, one sensor 120 is enough for a known field. Normally, the field is not known with enough exactness, however, and the change of position cannot be determined with enough exactness either due to gradients being too small. Specifically, magnetometers, WLAN sensors, mobile radio receivers, gyroscopes, acceleration sensors, Bluetooth sensors, or rotation rate sensors may be used. To increase the accuracy, several sensor devices (a unit of different sensors permitting a 6-axis determination) can be installed.

The invention discloses a method and a device for determining the change of position of 3D measuring heads in space. To this end, different sensors permitting a 6-axis determination of the change of position in space are installed fixedly with the measuring head (scanning head, viz. the part of a 3D measuring system that determines coordinate points in space), the change of position being determined with respect to three axes of displacement and three axes of rotation. Thus, it is possible to calculate the internal coordinate system Oₙ of the measuring head at a position n on the basis of the sensor data from the coordinate system Oₙ of the original position. The position n is generated by optionally displacing and rotating the sensor head in space from the original position. Having knowledge of the new coordinate system Oₙ it is possible to reliably register different views (patches) together, without other auxiliary means, respectively, to represent the 3D data points determined in the respective positions in one common world coordinate system.

1. Device for determining the change of position of a 3D measuring head, comprising:
a 3D measuring head;
at least one sensor device, integrated in the 3D measuring head, to detect a respective position-dependent measured quantity, the position-dependent measured quantity comprising a spatially inhomogeneous field; and
an evaluating device for determining a change of position of the 3D measuring head at a final position relative to a starting position from the at least one detected measured quantity;
wherein the change of position includes a displacement in space and a rotation in space; and
wherein the change of position in space can be determined with respect to three linearly independent axes of displacement of the internal coordinate system of the starting position or the final position, and the rotation in space can be determined with respect to three linearly independent axes of rotation of the internal coordinate system of the starting position or the final position.

2. Device according to claim 1, wherein the evaluating device is further adapted to determine changes of position at further final positions.

3. Device according to claim 1, wherein the evaluating device is further adapted to calculate an internal coordinate system of each final position on the basis of the internal coordinate system of the starting position.

4. Device according to claim 1, wherein each sensor device comprises one sensor or several sensors.

5. Device according to claim 4, wherein each sensor is selected from the group comprising magnetometer, WLAN sensor, mobile radio receiver, gyroscope, Bluetooth sensor, acceleration sensor, and rotation rate sensor.

6. Device according to claim 1, further comprising:
means for generating the respective position-dependent measured quantity.

7. Device according to claim 1, wherein the 3D measuring head is as tactile measuring head, an optical measuring head, a light section sensor or a laser scanner.

8. Method for determining the change of position of a 3D measuring head, comprising the steps of:
moving the 3D measuring head from a starting position into a final position;
detecting at least one position-dependent measured quantity by a respective sensor device integrated in the 3D measuring head, the position-dependent measured quantity comprising a spatially inhomogeneous field; and
determining a change of position of the 3D measuring head at the final position relative to the starting position on the basis of the at least one detected position-dependent measured quantity;
wherein the determination of the change of position comprises the determination of a displacement in space and the determination of a rotation in space; and
wherein the change of position in space is determined with respect to three linearly independent axes of displacement of the internal coordinate system of the starting position or the final position, and the rotation in space is determined with respect to three linearly independent axes of rotation of the internal coordinate system of the starting position or the final position.

9. Method according to claim 8, wherein the following step is performed beforehand:
generating the position-dependent measured quantity.

10. Method according to claim 8, the method further comprising:
moving the 3D measuring head to further final positions, and determining the change of position at the further final positions.

11. Method according to claim 8, further comprising the step of:
calculating an internal coordinate system of each final position on the basis of the internal coordinate system of the starting position.

12. Method according to claim 11, wherein the three axes of displacement are identical with the three axes of rotation.

13. Method according to claim 12, wherein the three linearly independent position axes are perpendicular to one another and/or wherein the three linearly independent axes of rotation are perpendicular to one another.

14. Method according to claim 11, further comprising the step of:
registering the internal coordinate system of each final position in a world coordinate system.

15. Method according to claim 14, wherein points measured by the 3D measuring head are represented in the world coordinate system.
